(19) United States
(12) Patent Application Publication
(10) Pub. No.: US 2006/0193071 A1
(43) Pub. Date: Aug. 31, 2006

(54) HIDID PreAmp-to-host interface with much reduced I/O lines

(76) Inventors: Davy H. Choi, Garland, TX (US); Michael Sheperek, Longmont, CO (US); Bryan E. Bloodworth, Irving, TX (US); Larry J. Koudele, Superior, CO (US)

Correspondence Address: TEXAS INSTRUMENTS INCORPORATED, P O BOX 655474, M/S 3999, DALLAS, TX, 75265, US

(21) Appl. No.: 11/069,031

(22) Filed: Feb. 28, 2005

(51) Int. Cl. G11B 5/09; G11B 5/02

(52) U.S. Cl. 360/46; 360/67

(57) ABSTRACT

The present invention achieves technical advantages as a Preamp enabled to use different functional blocks inside the Preamp only during their own “active” modes. When a block is “inactive”, its corresponding I/O's are put into the High-impedance (Hi-Z) state so that all of the other “inactive” blocks do not affect operation of the one “active” block.

### FIELD OF THE INVENTION

The present invention is generally directed to hard disk drives (HDDs), and more particularly to HDD PreAmps.

### BACKGROUND OF THE INVENTION

A conventional one-channel PreAmp 10 for a hard disk drive (HDD) is illustrated as a block diagram in FIG. 1. The PreAmp 10 is usually embodied on an integrated circuit (IC) chip 10, this conventional design being shown to have 15 I/O's: 11 of these are to be connected to the Host via a Flex Circuit, while the other 4 are to be connected to the Write Head and Read Head. A sizeable portion of the system cost is attributed to the Flex Circuit. Since the Flex Circuit can not currently be eliminated, cost reduction can be achieved by scaling down its number of I/O's.

### SUMMARY OF THE INVENTION

The present invention achieves technical advantages as a Preamp reduction scheme enabled to use different functional blocks inside the Preamp only during their own “active” modes. When a block is “inactive”, its I/O's will be put into High-impedance (Hi-Z) state so that all of the other “inactive” blocks do not affect operation of the one “active” block.

### BRIEF DESCRIPTION OF THE DRAWINGS

FIG. 1 is a block diagram of a conventional PreAmp;

FIG. 2 is a block diagram of one embodiment of the invention;

FIG. 3 is a schematic of a circuit adapted to trigger a reset operation; and

FIG. 4 is a schematic of a mode control circuit.

### DETAILED DESCRIPTION OF THE PREFERRED EMBODIMENT

Table 1 shows four typical PreAmp operating modes controlled by the serial-port bits MODE0 and MODE1, and a RWN pin:

TABLE 1
Typical Preamp operating modes.

| MODE1 | MODE0 | RWN | Mode |
|---|---|---|---|
| X | 0 | X | Sleep |
| 0 | 1 | X | Standby |
| 1 | 1 | 1 | Read |
| 1 | 1 | 0 | Write |

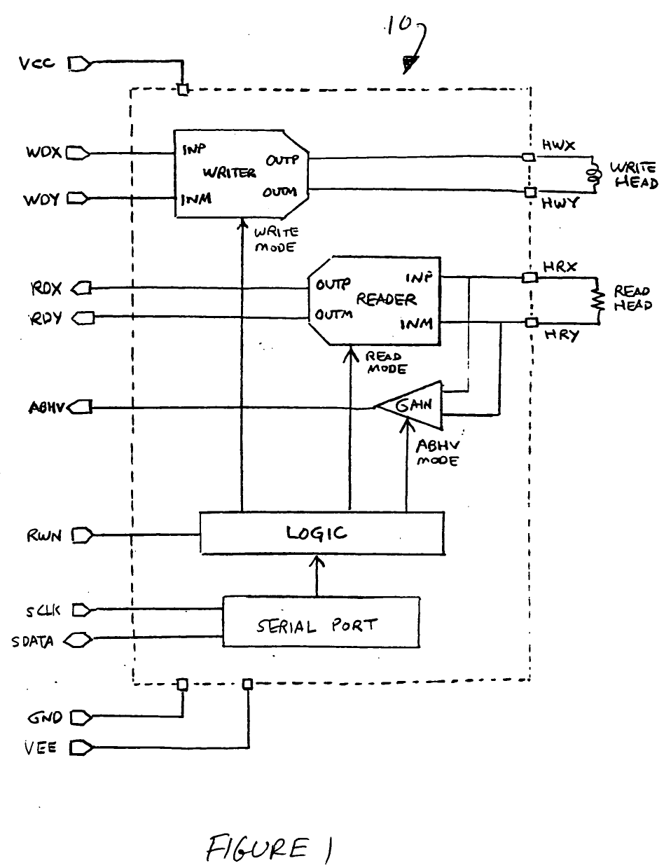

In a conventional design, such as shown at 10 in FIG. 1, the WRITER block is active only in the “write” mode, the READER block only in the “read” mode, and the GAIN block only in the “read” mode if a serial-port bit BHV goes high. The LOGIC and SERIAL PORT blocks are always active, but the serial port can accept commands in either “sleep”, “standby”, “read” or “write” mode.

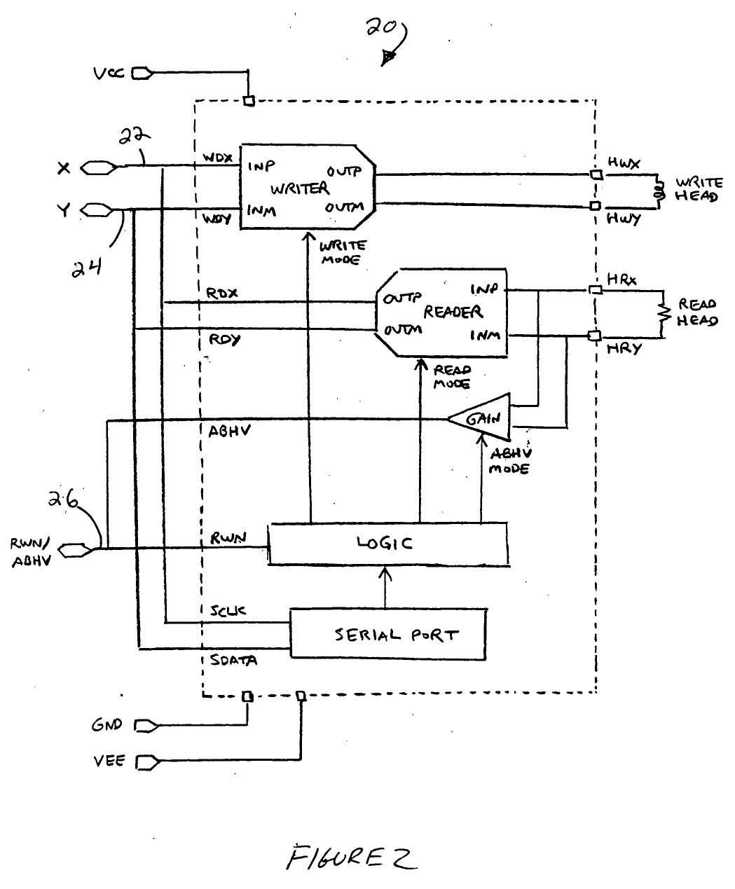

FIG. 2 shows a block diagram of a Preamp 20 according to one embodiment of the present invention with a reduced number of I/O's. I/O's WDX/RDX/SCLK are multiplexed together into one line X shown at 22, while I/O's WDY/RDY/SDATA are multiplexed into another line Y shown at 24. I/O's RWN and ABHV are also multiplexed together as shown at 26. In this way, the Preamp-to-Host I/O number decreases from 11 to only 6 as shown, with 3 I/O's servicing power needs.

It is also noted that I/O RDX and RDY can be swapped in their pairing with I/O WDX and WDY. The same goes for I/O SCLK and SDATA.

To make this embodiment of the invention work, three things are done:

1) Restrict the SERIAL PORT operation to “sleep” and “standby” modes only.

2) To exit from “read” or “write” modes, the user can exercise a Register Reset action. When the SERIAL PORT register contents are reset, the PreAmp 20 will automatically arrive at the “sleep” mode.

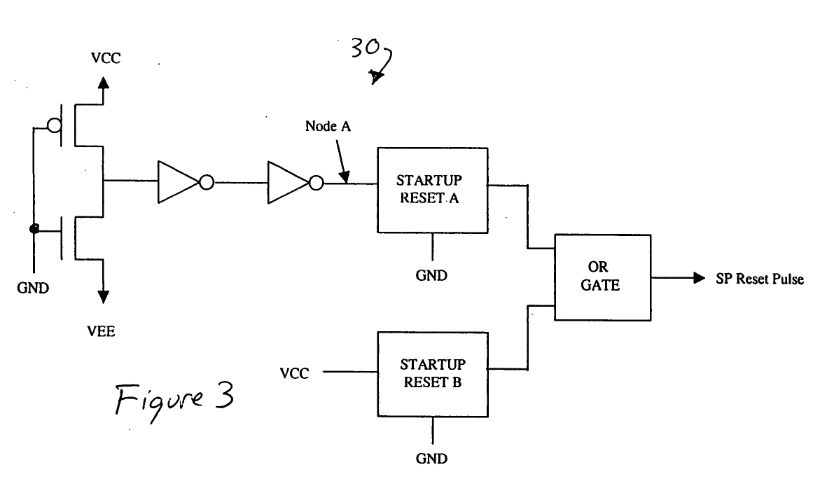

One method of triggering a Register Reset action is to force a VEE negative-voltage-to-zero-voltage transition. An implementation of such a scheme is illustrated at 30 in FIG. 3. Note that “dropping” the VEE has no other effects on the SERIAL PORT operation except for its content-reset because the SERIAL PORT is powered by the VCC-GND potential. A PMOS is a very “weak” device compared to the NMOS device. When VEE is at −2.1 V, Node A is sitting low. When VEE is dropped to 0 V, the NMOS is turned off, and Node A will move up towards VCC. In responding to a rising edge at its input, “Startup Reset A” output generates a pulse to reset the Serial Port. “Startup Reset B” can also generate a pulse when there is a VCC low-to-high transition. The two startup reset circuit outputs are OR'ed together to allow either output to reset the SP.

3) The value of the RWN I/O is stored during the “standby” mode, as a signal called sRWN. To activate the “abhV” mode both sRWN and BHV signals should be high to enable both the READER and GAIN blocks. Thus, the RWN signal ceases its control of the ABHV function. As a result, the RWN/ABHV I/O becomes free, and it is made available to output the GAIN output result.

To explain further, the output of the GAIN block, called ABHV (short for Analog Buffer Head Voltage), is just an amplified version of the Read Head signal. The ABHV signal can be made available only when the READER block is also enabled. Thus, the ABHV signal cannot multiplex with the RDX or RDY I/O.

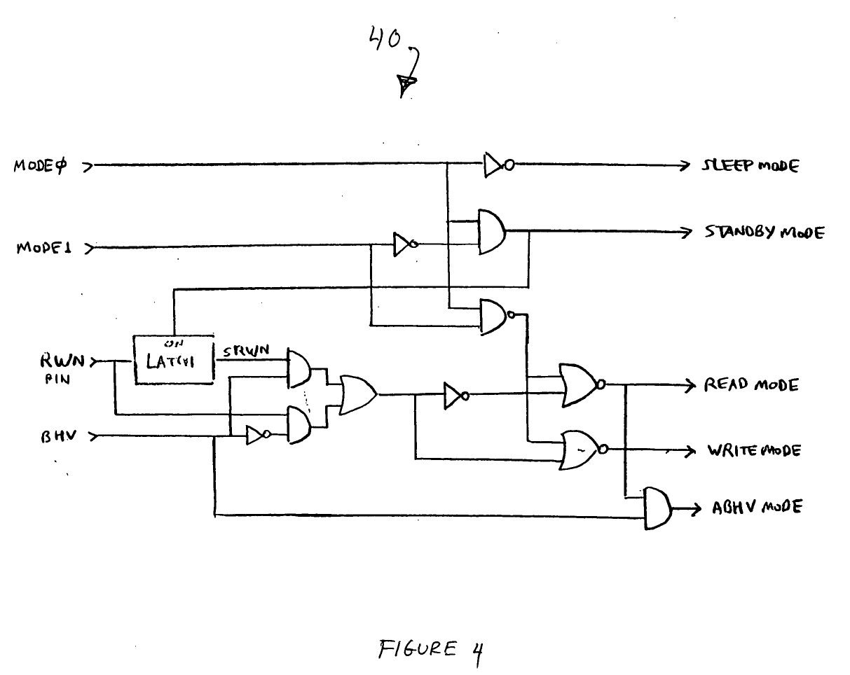

Effectively, there are at least two methods of enabling the READER block depending on the state of the BHV serial-port bit. A mode-control logic schematic is illustrated at 40 in FIG. 4.

The distinction between RWN and sRWN is made because there is a critical speed requirement to switch from the “write” mode to the “read” mode for normal HDD operation. A RWN change of state from “0” to “1” through the I/O does not impair the speedy write-to-read transition. However, this will not be the case should a write-to-read operation be triggered via a slow serial-port operation of changing sRWN value from “0” to “1”. Since the ABHV function is a slow test mode used in HDD assembly, the sRWN signal can be used comfortably as described.

To provide SERIAL PORT programming in “read” mode, this embodiment of the invention can be re-configured to only multiplex I/O WDX with SCLK, and I/O WDY with SDATA. By providing separate I/O's for RDX and RDY, both the READER and SERIAL PORT blocks are now fully functional. The penalty is the requirement of having two extra I/O's—going up from 6 to 8.

The present invention advantageously utilizes only one IC chip to operate, provides simplicity, and hence lower cost and speedy operation.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A PreAmp, comprising:
a circuit having a plurality of I/O's adapted to receive control signals, an output adapted to control a read head and a write head, and wherein the I/O's are multiplexed.

2. The PreAmp as specified in claim 1 further comprising a read input and write input multiplexed onto a common said I/O.

3. The PreAmp as specified in claim 2 wherein a clock signal is also multiplexed onto the common I/O.

4. The PreAmp as specified in claim 3 wherein 2 of the I/O's are adapted to accept all read, write, and clock signals.

5. The PreAmp as specified in claim 2 wherein the common I/O is adapted to also receive a multiplexed RWN and ABHV signal.

6. The PreAmp as specified in claim 1 wherein the PreAmp has less than 8 total said I/O's.

7. The PreAmp as specified in claim 6 wherein the PreAmp has no more than 6 total said I/O's.

8. The PreAmp as specified in claim 2 wherein the circuit is adapted to receive a WDX and a RDX signal multiplexed on said I/O.

9. The PreAmp as specified in claim 8 wherein the circuit is adapted to receive a WDY and RDY signal multiplexed on a single said I/O line.

10. The PreAmp as specified in claim 3 wherein the circuit is adapted to receive a WDX, RDX and SCLK signal multiplexed on a single said I/O line.

11. The PreAmp as specified in claim 10 wherein the circuit is adapted to receive a WDY, RDY and SDATA signal multiplexed on a single said I/O line.
